(19) United States
(12) Patent Application Publication
(10) Pub. No.: US 2017/0351048 A1
(43) Pub. Date: Dec. 7, 2017

(54) SHIELDING PLATE OF LENS STRUCTURE AND LENS STRUCTURE

(71) Applicant: Newmax Technology Co., Ltd., Taichung City (TW)

(72) Inventor: Meng-Chen Chi, Taichung City (TW)

(21) Appl. No.: 15/175,381

(22) Filed: Jun. 7, 2016

(51) Int. Cl. G02B 7/02; G02B 5/00

(52) U.S. Cl. CPC G02B 7/02; G02B 5/003

(57) ABSTRACT

A shielding plate includes a main body. A center of the main body has a through hole. The main body defines a circle center, the main body is partitioned into at least two larger diameter portions and at least two smaller diameter portions in central angles, the larger diameter portions and the smaller diameter portions are arranged alternatively around the circle center, and a distance from an outer edge of each said larger diameter portion to the circle center is greater than a distance from an outer edge of each said smaller diameter portion to the circle center so that a fringe of the main body is non-circular.

### BACKGROUND OF THE INVENTION

### Field of the Invention

The present invention relates to a shielding plate of lens structure and a lens structure.

### Description of the Prior Art

A common lens structure is usually provided with a shielding plate to decrease diffused light, and the shielding plate is often round and has a through hole at an center thereof for light to pass therethrough. However, because the shielding plate is disposed between a lens base and a lens, and the shielding plate is abutted against by the lens, a stress is produced. The lens receives a counterforce from the shielding plate and is thus unable to be assembled precisely.

The present invention has arisen to mitigate and/or obviate the afore-described disadvantages.

### SUMMARY OF THE INVENTION

The major object of the present invention is to provide a shielding plate of lens structure and a lens structure which can reduce a stress from a lens after the lens structure is assembled so as to ensure the shielding plate can be assembled precisely in the lens.

To achieve the above and other objects, a shielding plate of lens structure and a lens structure is provided, including: a main body, a center of the main body having a through hole, the main body defining a circle center, the main body being partitioned into at least two larger diameter portions and at least two smaller diameter portions in central angles, the larger diameter portions and the smaller diameter portions being arranged alternatively around the circle center, a distance from an outer edge of each said larger diameter portion to the circle center being greater than a distance from an outer edge of each said smaller diameter portion to the circle center so that a fringe of the main body is non-circular.

To achieve the above and other objects, a lens structure is provided, including the shielding plate mentioned above, a lens base and at least one lens. The shielding plate is disposed between the lens base and the lens.

Thereby, the shielding plate can reduce a stress from a lens after the lens structure is assembled so as to ensure that the shielding plate can be assembled precisely in the lens.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a shielding plate of a first embodiment of the present invention;

FIG. 2 is a front view of other modes of the shielding plate of the first embodiment of the present invention;

FIG. 3 is a stereogram of the shielding plate of a second embodiment of the present invention;

FIG. 4 is a front view of other modes of the shielding plate of the second embodiment of the present invention;

FIG. 5 is a stereogram of the shielding plate of a third embodiment of the present invention;

FIG. 6 is a front view of other modes of the shielding plate of the third embodiment of the present invention;

FIG. 7 is a perspective breakdown view of a lens structure of the present invention;

FIG. 8 is a front view of the lens structure of the present invention;

FIG. 9 is a cross-sectional view of the lens structure of the present invention; and

FIGS. 10 to 12 are comparison charts showing stress distributions of the shielding plate of the present invention and a conventional shielding plate.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

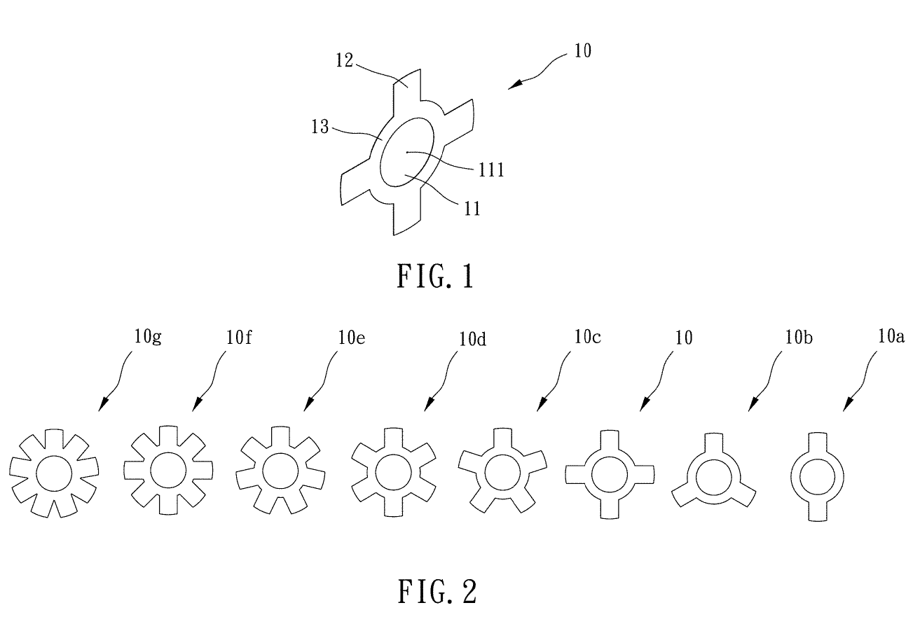

Please refer to FIGS. 1, 3 and 5 for a shielding plate of a lens structure of the present invention, including a main body 10, 20, 30 which may be made of plastic or metal materials, a center of the main body 10, 20, 30 having a through hole 11, 21, 31, the main body 10, 20, 30 defining a circle center 111, 211, 311, the main body 10, 20, 30 being partitioned into at least two larger diameter portions 12, 22, 32 and at least two smaller diameter portions 13, 23, 33 in central angles of the circle center 111, 211, 311, the larger diameter portions 12, 22, 32 and the smaller diameter portions 13, 23, 33 being arranged alternatively around the circle center 111, 211, 311, a distance from an outer edge of each said larger diameter portion 12, 22, 32 to the circle center 111, 211, 311 being greater than a distance from an outer edge of each said smaller diameter portion 13, 23, 33 to the circle center 111, 211, 311 so that a fringe of the main body 10, 20, 30 is non-circular. Preferably, each said larger diameter portion 12, 22, 32 occupies a same central angle, each said larger diameter portion 13, 23, 33 occupies a same central angle, and the outer edges of each said larger diameter portion 12, 22, 32 and each said smaller diameter portion 13, 23, 33 being farthest from the circle center 111, 211, 311 are curved.

Specifically, in a first embodiment, there are respectively four said larger diameter portions 12 and four said smaller diameter portions 13; however, as shown in FIG. 2, the main body. 10a, 10b, 10c, 10d, 10e, 10f, 10g has different numbers of larger diameter portions or smaller diameter portions. Of course, the main body may be in other shapes such as triangular or polygonal but not limited to a multi-petal shape as shown in FIG. 1.

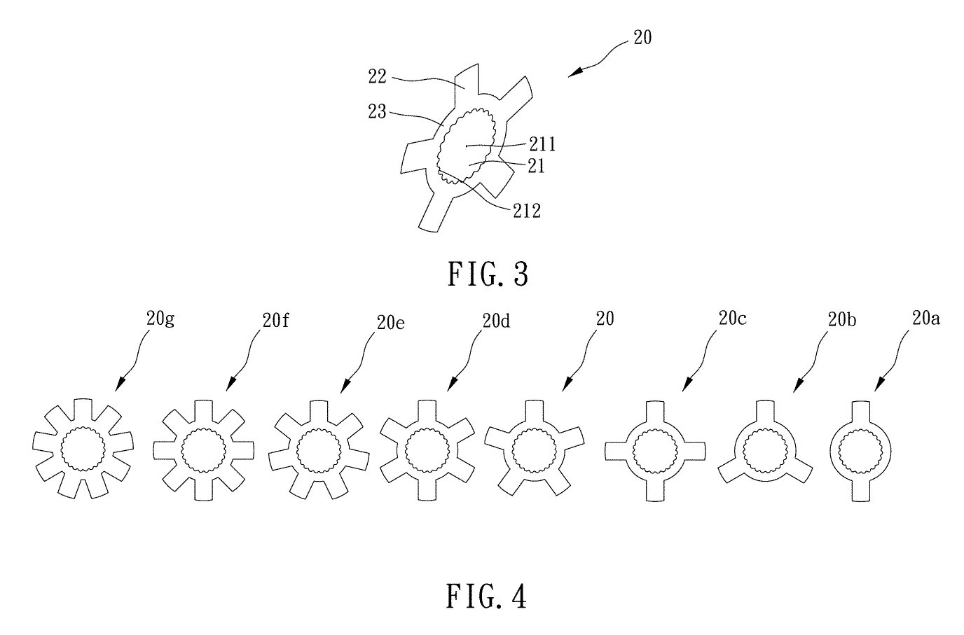

In addition, please refer to FIGS. 3 and 4. In this embodiment, a surface of an inner edge of the through hole 21 of the main body 20, 20a, 20b, 20c, 20d, 20e, 20f, 20g has a plurality of recesses formed radially outwardly, and the recesses and the surface of the inner edge of the through hole define a plurality of micro-structures 212 which are rugged to decrease diffused light.

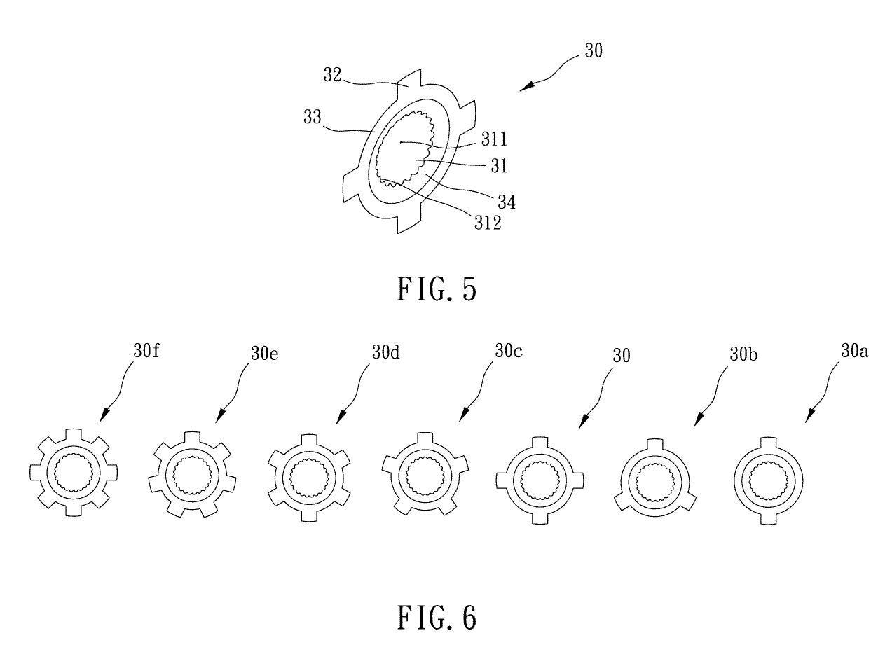

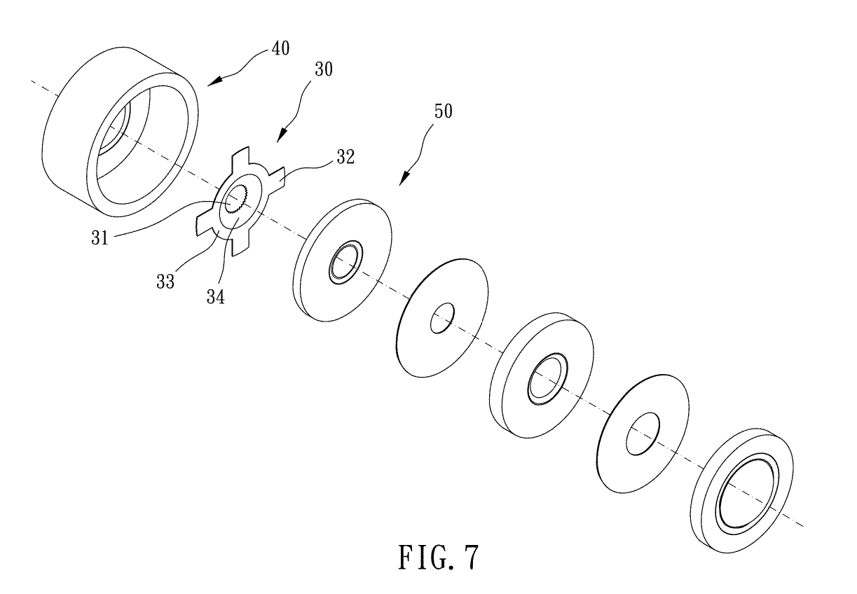

Furthermore, as shown in FIGS. 5 and 6, the main body 30, 30a, 30b, 30c, 30d, 30e, 30f defines an axis penetrating through the circle center 311 and perpendicular to the main body 30, 30a, 30b, 30c, 30d, 30e, 30f, the main body 30, 30a, 30b, 30c, 30d, 30e, 30f includes a protrusion 34 around the through hole 31, and the protrusion 34 protrudes along the axis so that the through hole 31 and the main body 30, 30a, 30b, 30c, 30d, 30e, 30f exclusive of the protrusion 34 are on different planes so as to cooperate with a lens which is convex. Preferably, a surface of an inner edge of the through hole 31 of the main body 30, 30a, 30b, 30c, 30d, 30e, 30f has a plurality of recesses formed radially outwardly, and the recesses and the surface of the inner edge of the through hole define a plurality of micro-structures 312 which are rugged.

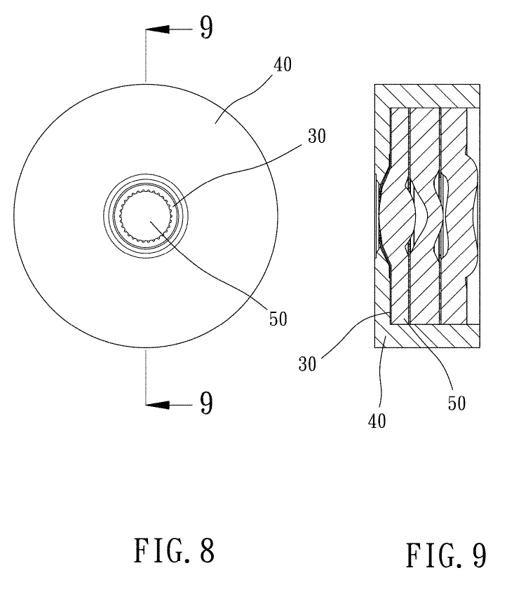

Please refer to FIGS. 7 to 9 for a lens structure, including the shielding plate mentioned above (in this embodiment, the main body 30 in FIG. 5 is taken as an example), and further including a lens base 40 and at least one lens 50, the shielding plate is disposed between the lens base 40 and the lens 50. Specifically, the shielding plate is located between the lens base and a first lens. More specifically, a front end face of the lens base 40 has an opening, a center of the lens 50 has an optical portion, the opening, the through hole and the optical portion correspond to one another, and the larger diameter portions 32 are disposed between the lens base 40 and the lens 50 so as to fix a position of the main body 30.

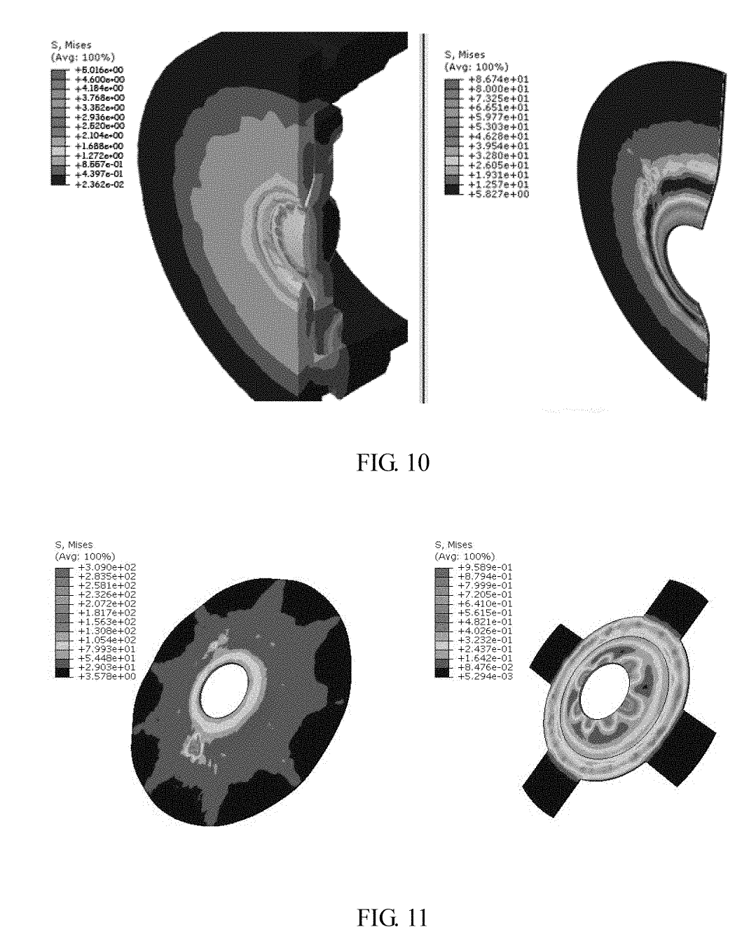

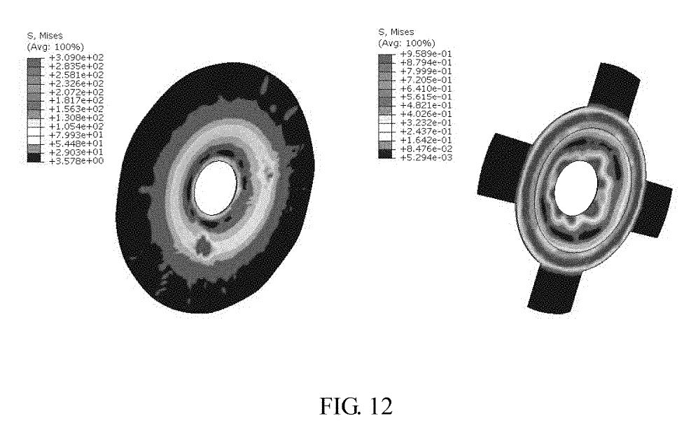

Please refer to FIGS. 10 to 12 for actual efficacy of the shielding plate of the present invention. The present invention (the charts on the right side of FIGS. 10 to 12) and a conventional circular shielding plate (the charts on the left side of FIGS. 10 to 12) are experimented under the same conditions to see the stress distributions. A circumference of the conventional circular shielding plate is circular, so the circumference of the shielding plate is squeezed and contacted by the first lens of the lens structure, and the shielding plate receives a relatively greater stress. It can be seen from the charts that the stress of a part near a through hole of the conventional circular shielding plate is obviously greater; and the circumference of the shielding plate of the present invention is cut to form the at least two larger diameter portions, and only the larger diameter portion is squeezed and contacted by the first lens of the lens structure. Therefore, the shielding plate of the present invention receives less stress than the shielding plate of the conventional circular shielding plate, so the shielding plate of the present invention can effectively decrease stress.

Given the above, the shielding plate of the present invention can effectively decrease the stress produced when the shielding plate is squeezed by the lens so as to ensure that the lens and elements are precisely assembled and further to elevate an imaging efficacy.

While we have shown and described various embodiments in accordance with the present invention, it should be clear to those skilled in the art that further embodiments may be made without departing from the scope of the present invention.

What is claimed is:

1. A shielding plate of a lens structure, including a main body, a center of the main body having a through hole, the main body defining a circle center, the main body being partitioned into at least two larger diameter portions and at least two smaller diameter portions in central angles, the larger diameter portions and the smaller diameter portions being arranged alternatively around the circle center, a distance from an outer edge of each said larger diameter portion to the circle center being greater than a distance from an outer edge of each said smaller diameter portion to the circle center so that a fringe of the main body is non-circular.

2. The shielding plate of lens structure of claim 1, wherein each said larger diameter portion occupies a same central angle, and each said smaller diameter portion occupies a same central angle.

3. The shielding plate of lens structure of claim 2, wherein the outer edge of each said larger diameter portion and each said smaller diameter portion being farthest from the circle center are curved.

4. The shielding plate of lens structure of claim 1, wherein the main body defines an axis penetrating through the circle center and perpendicular to the main body, the main body includes a protrusion around the through hole, and the protrusion protrudes along the axis so that the through hole and the main body exclusive of the protrusion are on different planes.

5. The shielding plate of lens structure of claim 1, wherein a surface of an inner edge of the through hole has a plurality of recesses formed radially outwardly, and the recesses and the surface of the inner edge of the through hole define a plurality of micro-structures which are rugged.

6. A lens structure, including:
a shielding plate, the shielding plate including a main body, a center of the main body having a through hole, the main body defining a circle center, the main body being partitioned into at least two larger diameter portions and at least two smaller diameter portions in central angles, the larger diameter portions and the smaller diameter portions being arranged alternatively around the circle center, a distance from an outer edge of each said larger diameter portion to the circle center being greater than a distance from an outer edge of each said smaller diameter portion to the circle center so that a fringe of the main body is non-circular;
a lens base;
at least one lens;
wherein the shielding plate is disposed between the lens base and the lens.

7. The lens structure of claim 6, wherein each said larger diameter portion occupies a same central angle, and each said smaller diameter portion occupies a same central angle.

8. The lens structure of claim 7, wherein the outer edges of each said larger diameter portion and each said smaller diameter portion being farthest from the circle center are curved.

9. The lens structure of claim 6, wherein the main body defines an axis penetrating through the circle center and perpendicular to the main body, the main body includes a protrusion around the through hole, and the protrusion protrudes along the axis so that the through hole and the main body exclusive of the protrusion are on different planes.

10. The lens structure of claim 6, wherein a surface of an inner edge of the through hole has a plurality of recesses formed radially outwardly, and the recesses and the surface of the inner edge of the through hole define a plurality of micro-structures which are rugged.
